(19) United States
(12) Patent Application Publication
(10) Pub. No.: US 2003/0094174 A1
(43) Pub. Date: May 22, 2003

(54) Respirator mask and method of its manufacture

(76) Inventors: Andreas Velten, Genthin (DE); Norbert Schilling, Neubrunn (DE)

Correspondence Address: Law Offices of Karl Hormann, 86 Sparks Street, Cambridge, MA, 02138-2216, US

(21) Appl. No.: 09/995,983

(22) Filed: Nov. 21, 2001

(51) Int. Cl. A62B 7/00

(52) U.S. Cl. 128/200.24

(57) ABSTRACT

The invention relates to a novel respiratory mask comprising a manifold provided with a manifold for a breathable gas supply line and a pair of nares elements connected with the manifold and a substantially hermetic seal over the nostrils of a patient and the nares elements formed by in situ spray coating of a quick-setting elastomeric material around the manifold.

### BACKGROUND OF THE INVENTION

1. Field of the Invention

The invention, in general, relates to a novel respirator mask and, more particularly, of a respirator mask which provides for proper fit between the nostrils of a person and gas supply nipples or naris elements of the mask. It also relates to a method of manufacturing such a mask.

2. The Prior Art

Positive pressure nasal respiration of a patient is used in medical facilities as well as in home care and ambulatory vehicles especially for intensive respiration. It is also used in nCPAP therapy (nasal continuous positive airway pressure therapy) for treating obstructive sleep apnea. It requires a continuous or periodic application of breathable air under positive pressure to the air passages by way of a patient's nostrils. For this purpose, it is important to provide for as air-tight a connection as possible between the ends of the air supply pipes and the patient's nostrils. The tight connection is usually realized by respiration masks or nasal puffs.

U.S. Pat. No. 4,782,832 discloses a nasal puff provided with two nares elements for insertion into nostrils and supported by a basic structure connected to the supply ducts for breathable air. The position or orientation of the nares elements is adjustable. For contact with the nostrils, the nares elements are covered by an elastic material which may be shaped in different ways. The mask is maintained in its position by a harness adapted to engage the head of a patient, such that the elastic material covering the nares elements is pressed into or against the nostrils. By the adjustability of the nares elements, their different configurations and the use of an elastic material for contacting the nostrils, the nasal puff is not only said to be individually adaptable to different positions and shapes of nostrils but also to provide for an air-tight connection between the mask and the nostrils. Even when the patient is moving, the tight connection should, if possible, be maintained. The drawback of the nasal puff described in U.S. Pat. No. 4,782,832 is that its manufacture is rather complex. Its complex manufacture notwithstanding, the mask suffers from the further disadvantage that the many different positions and shapes of nostrils, particularly during movement of a patient, often mitigate against a tight connection between nostrils and the variable and elastically deformable nares elements of the respiration mask. When leaks occur, respiration is in practice often attempted either by increasing the respiration pressure to compensate for the deficit of breathable air resulting from such leak or by more strongly pushing the elastic material covering the nares elements against the nostrils such that under the effect of the counteracting forces the elastic material as well as the nostrils are deformed into tight engagement. Increased respiratory pressure often leads to anatomic changes in and, hence, to damage of, in the upper air passages. Increased engagement force acting on the nares elements subjects the patient to considerable discomfort, perhaps even pain, especially if the nasal puff has to be worn for an extended period.

French patent specification describes a method of fabricating a respiration mask or nasal puff to fit an individual. It involves making a cast of the nose of the patient to be respirated which is then used as a casting mold to make a respiration mask to fit the patient's nose. Air supply ducts within the mask are positioned such that the breathable air may flow into the patient's nostrils. The mask fabricated in this manner is maintained in position by straps wrapped around the patient's head. Since it is of a custom-fitted or “bespoke” configuration it snugly engages the patient's nose and insures an air-tight or hermetic connection between the feed duct of breathable air and the patient's nostrils. The disadvantages of the mask are the high complexity of, and the considerable time required for, its fabrication. These, in turn, lead to the further disadvantage of the respiration mask not being readily available in case of an emergency of the kind requiring immediate respiration of the patient. Hence, this respiration mask, too, is limited in its applicability.

### OBJECT OF THE INVENTION

It is an object of the invention to provide an individual respiration mask which can easily be fabricated and which has a wide field of application.

It is a further object of the invention to provide an individual respiration mask which can be made simply and quickly, and which insures a proper fit and hermetic connection with a patient's nostrils regardless of position and shape of his nostrils and regardless of his movements.

In addition, it is an object of the invention to provide a method of fabricating such an individual respiration mask.

### SUMMARY OF THE INVENTION

In the accomplishment of these and other objects the invention provides for an individual respiration mask or nasal puff and for a method of its fabrication along with advantageous features thereof, as will hereinafter be described in greater detail.

The respiration mask in accordance with the invention comprises a manifold provided with a connector for a breathable gas supply line as well as two hose-like end pieces or nares elements connected to the connector and insertable in the nostrils of a patient. The manifold may be made to fit the configuration of a patient's nose by a quick-setting medical grade elastomeric material having a hardness of between 10 and 70, preferably 40 (Shore A) which is spray-coated in situ around the manifold and, if necessary, adjacent facial portions of the patient, after the manifold has been positioned on the patient with the nares element inserted in his nostrils. The elastomeric material may be, for instance, a silicon rubber which after setting or curing retains a hardness in the preferred range. Together, the manifold and the elastomeric material, by forming a substantially hermetic seal over the nostrils and the nares elements, constitute the body of the mask which exactly fits the shape of the nose and, optionally, adjacent sections of the patient's face, in particular the area over the upper lip. The hose-like end pieces or nares elements, are arranged within the manifold or plenum chamber such that they are inserted in the patient's nostrils when the mask is worn. The medical elastomeric material reproduces, or precisely adapts itself to, the shape of the patient's nose insuring a proper fit of the plenum chamber with the hose-like nares elements being retained in the nostrils in a position comfortable to the patient and efficacious for nasal respiration. Efficaciously and in order better to adapt itself to, or fit, a patient, the plenum chamber is made of a soft elastically deformable material, and the length of its hose-like nares elements is adjustable.

For a proper functioning of the mask it may also be advantageous to provide in the manifold a valve-like exhalation passage functioning as an overflow and/or pressure relief valve. The connector for a breathable gas supply line extends outwardly from the body of the mask so that it may be connected to such duct with ease. The individual respiration mask may be secured to a patient by straps wrapped around his head. To this end, the mask is provided with appropriate brackets. These may either be attached directly to the manifold or they may be imbedded in the medical elastomeric material.

The special advantage of the individual respiration mask in accordance with the invention is that its body is shaped precisely to fit the shape of a patient's nose as well as, if necessary, adjacent facial areas, so that it fits without undue application of pressure enabling the patient to be respirated by way of the hose-like nares pieces inserted in his nostrils. Since a secure fit of the respiration mask is achieved without undue application of force, a patient will not find wearing the mask, even for extended periods, to be cumbrous or particularly unpleasant.

The method in accordance with the invention of fabricating an individual respiration mask of the kind described is such that two hose-like end pieces or nares elements of a manifold preferably made of soft elastically deformable material are inserted into the nostrils of a patient, after possibly appropriately adjusting their length to the patient's nostrils in order to improve the fit of the mask, and that thereafter the manifold and the nose of the patient as well as, if necessary, the facial sections adjacent to the nose are spray-coated with a quick-setting medical-grade elastomeric material such that a respiration mask is created in situ which fits the patient and from which the connector for the breathable gas supply line is extending. For affixing holding straps on the respiration mask it is efficacious to insert them into the elastomeric material, before it has set, at the side opposite the patient's nose. Once the material has set or hardened the straps are securely connected to the mask. The method in accordance with the invention makes it possible quickly and without undue effort to produce an individually fitting respiration mask which without undue application of force snugly encloses the nose, nostrils and, if necessary, adjacent facial sections. The method may be practiced anywhere and makes it possible within a very short time to fabricate an individual respiration mask in the presence of a patient. Hence, it is particularly suited for making respiration masks for emergency respiratory action.

### DESCRIPTION OF THE SEVERAL DRAWINGS

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

FIG. 1 is a top elevation of the manifold;

FIG. 2 is a side elevation of the manifold;

FIG. 3 depicts the manifold mounted on a patient;

FIG. 4 is a front view depicting a respiration mask mounted on a patient; and

FIG. 5 is a side view depicting a respiration mask mounted on a patient.

### DETAILED DESCRIPTION OF AN EMBODIMENT

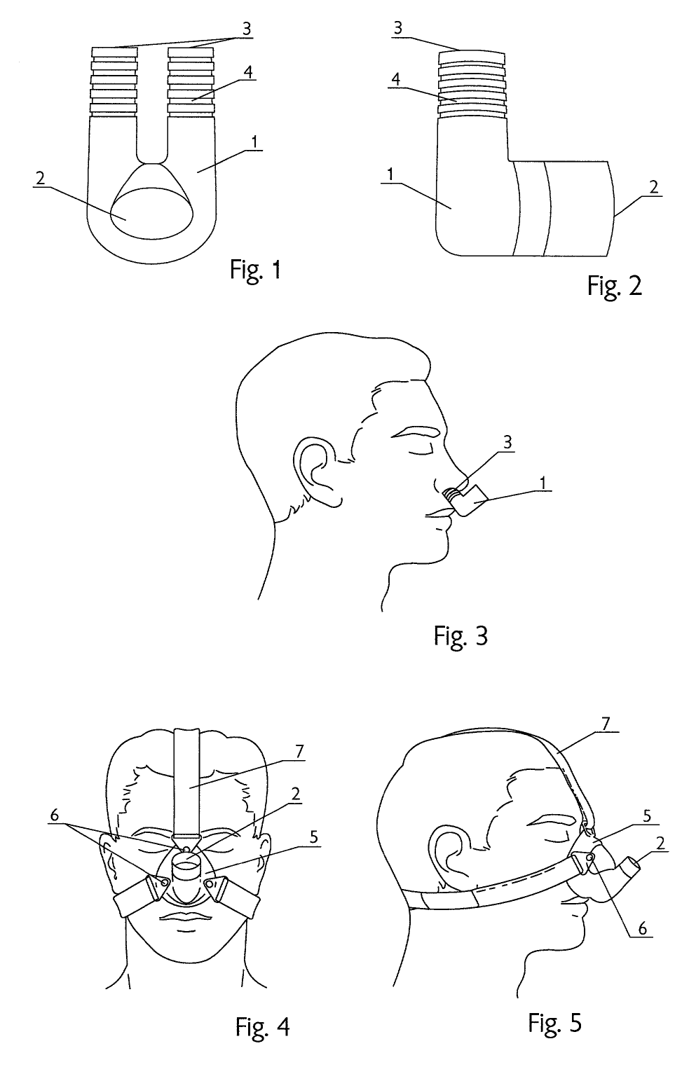

A manifold 1 shown in FIGS. 1 and 2 is provided with an connector 2 for a breathable gas supply line (not shown) as well as with two hose-like end pieces or nares elements 3 for insertion into a patient's nose. The connector 2 and hose-like nares elements 3 are connected with each other to allow breathable air to flow into a patient's nostrils. The manifold 1 is made of a soft elastically deformable material. Circumferential recesses or corrugations 4 provided in the hose-like nares elements 3 facilitate their being fitted to the patient's nose as well as their longitudinal adjustment. FIG. 3 depicts a manifold 1 with the hose-like nares elements 3 being inserted in the nostrils of a patient. In accordance with the invention the manifold thus fitted to the patient, the patient's nose and, if necessary, the facial sections adjacent to the nose are spray-coated with a quick-setting medical elastomeric material, preferably of hardness 40, thus forming an individual respiration or breathing mask 5 as shown in FIGS. 4 and 5. A body formed in the individual breathing mask 5 is provided with support elements 6 for attaching straps 7 for being wrapped around the patient's head to maintain the mask 5 in its position.

What is claimed is:

1. A respiration mask adapted to fit an individual patient, comprising:
a manifold adapted to be placed in close proximity of the nose of the patient and comprising a connector for a breathable gas supply line;
two hose-like nares elements connected with the connector and adapted to form a connection with the nostrils of the patient by insertion therein; and
a substantially hermetic seal covering the manifold and formed in situ by spraying of a quick-setting soft medical grade elastomeric material.

2. The respiration mask of claim 1, wherein the manifold comprises a soft elastically deformable material.

3. The respiration mask of claim 1, further comprising means for adjusting the length of the nares-pieces.

4. The respiration mask of claim 3, wherein the means for adjusting the length comprises a circumferential in the nares element.

5. The mask of claim 1, wherein the manifold further comprises a valve-like passage.

6. The mask of claim 5, wherein the valve-like passage comprises one of an overflow valve and a pressure relief valve.

7. The mask of claim 1, wherein the medical-grade elastomeric material is of the quick-setting kind having a terminal hardness of between 10 and 70.

8. The mask of claim 7, wherein the hardness is 40 (Shore A).

9. The mask of claim 1, further comprising means attached to the manifold for securing the mask to the patient.

10. The mask of claim 9, wherein the securing means comprises protrusions extending from a surface of the manifold opposite the patient's nose and through the medical elastomeric material.

11. The mask of claim 10, further comprising straps attached to the protrusions.

12. A method of making a respiration mask for an individual patient, comprising the steps of:
providing a manifold having a connector for a breathable gas supply line and a pair of nares elements adapted to form a connection with the patient's nostrils by insertion therein;
placing the manifold in close proximity to the nose and inserting the nares elements in the nostrils; and
spray-coating of a quick-setting soft elastomeric material around the manifold to form a substantially hermetic seal over the nostrils and the nares elements.

13. The method of claim 12, further comprising the step of spray-coating the elastic polymeric material over adjacent facial sections of the patient.

14. The method of claim 12, further comprising the step of implanting in the polymeric material at the side thereof opposite the nose means for attaching straps to secure the mask to the head of the patient.
